(19) United States
(12) Patent Application Publication
(10) Pub. No.: US 2006/0237044 A1
(43) Pub. Date: Oct. 26, 2006

(54) Dishwasher with controlled induction motor/pump

(76) Inventors: Jerry Wayne Ferguson, Greenwood, MS (US); John Patrick Picardat, Greenwood, MS (US); Oyvin Haugan, Houston, TX (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/204,458

(22) Filed: Aug. 16, 2005

Related U.S. Application Data
(60) Provisional application No. 60/674,510, filed on Apr. 25, 2005.

(51) Int. Cl. B08B 7/04; B08B 3/00; B08B 3/04; B08B 3/12

(52) U.S. Cl. 134/34; 134/56 D; 134/58 D; 134/104.2; 134/10; 134/18; 134/184; 134/172

(57) ABSTRACT

A dishwasher having a speed-controlled induction motor coupled to a pump to drive the pump during dishwasher operation. A motor controller is connected to the induction motor to control the speed of operation of the induction motor. A dishwasher controller is connected to the motor controller for sending signals to, and receiving signals from, the motor controller during operation to control the motor speed. The flow rate of water through the pump discharge to a spray arm is controlled based on the phase of the wash cycle and the condition of the filter that blocks food debris from entering the sump. The motor speed is decreased to decrease the pump flow rate when the flow rate through the filter decreases in an early phase of the wash cycle. The motor speed is increased to increase the pump flow rate during later phases of the wash cycle. In steady state operation, the flow rate through the filter is matched to the flow rate through the pump discharge.

### CROSS-REFERENCE TO RELATED APPLICATION

This application claims the benefit of U.S. Provisional Application 60/674,510, filed Apr. 25, 2005, incorporated by reference herein in its entirety.

### BACKGROUND OF INVENTION

The present invention relates generally to dishwasher motor and pump systems and, more particularly, to a dishwasher with a controlled induction motor.

Over the history of domestic dishwasher design the sophistication and efficiency of these machines has increased at a slow and uneven pace. The driving force behind most of the early developments in domestic dishwasher design has been the desire to produce a lower cost machine.

In roughly the last ten years the sophistication of domestic dishwasher design has accelerated significantly driven by the need for increased energy efficiency; consumer demand for better wash performance; and the emergence of a “high end” market that can support more expensive and sophisticated designs. In addition, competition from more efficient and quieter European designs and the emergence of powerful and low cost microprocessor controls and switching power supplies has accelerated the development of more sophisticated dishwasher designs.

The standard or most common dishwasher designs throughout most of the 1970's and 1980's were relatively simple with equally simple wash cycles. The typical dishwasher design used a simple coarse filtration system, or no filtration at all, and relied heavily on water changes to help dilute the food soil. The controls were usually electromechanical timers, which were very limited in the tasks that they could perform. If there were electronic controls, they were also relatively simple and basically emulated the functionality of an electromechanical timer.

The motors in use then and now were almost exclusively single-phase, asynchronous induction motors. These motors are relatively simple and do not, in general, require separate motor controllers. The only additional components required, if any, are start relays for split resistance designs, capacitors for split capacitor motors (used primarily in Europe), and start capacitors for capacitor start motors.

Some of the limitations of the single-phase inductions motors are as follows:
1. speed not controllable—the asynchronous single-phase designs typically rotate at approximately 3200 to 3500 revolutions per minute (rpm) depending on the torque loading; the synchronous single-phase designs typically run at 3600 rpm for 60 Hz power supplies;
2. relatively inefficient—some of the designs such as the shaded pole induction motor can have efficiencies as low as 28%;
3. relatively low starting torques;
4. lack of feedback as to their current state, e.g., speed, torque, power draw, etc.;
5. relatively noisy—single-phase motors suffer from 120 Hz torque pulsations; these pulsations are transmitted to the dishwasher structure and produce audible, difficult to control acoustical noise.

### SUMMARY OF THE INVENTION

The present invention provides a three-phase controlled induction motor and pump system for a dishwasher. The speed and other information from the motor/pump are measured and controlled by the dishwasher's microprocessor controller.

In one aspect of the invention, an electronic motor controller is connected to the induction motor to control the speed of operation of the pump motor as different conditions arise in the dishwasher over the course of a cleaning cycle. A dishwasher controller receives loading signals from the motor controller and sends commands to the motor controller to adjust the speed of the pump motor.

In another aspect of the invention, the flow rate of water through the pump discharge to a rotating spray arm is controlled based on the phase of the wash cycle and the condition of the filter that blocks food debris from entering the sump. The motor speed is decreased to decrease the pump flow rate when the flow rate through the filter decreases in an early phase of the wash cycle as food debris collects and partially blocks the filter. The motor speed is increased to increase the pump flow rate during later phases of the wash cycle when the items being washed are relatively clean. In steady state operation, the flow rate through the filter is matched to the flow rate through the pump discharge.

This motor pump design and operation has several features that are improvements over the prior art, which are described in the following paragraphs.

Maintaining Optimal Filter Operation—this invention allows for efficient use of the filter during the wash cycle. Because of this less water and time is required to remove the food soil from the dishes. Conventional wash systems generally known in the art do not adjust the pump's flow rate to match the capacity of the filter. Because of this the openings in the filter media are made larger to prevent clogging. The filter media with larger openings requires more water changes to remove the food soil than would be the case if the holes were smaller and the flow rate matched the filter's capacity at all time. Because less water changes or wash phases are required, the time required to wash the dishes is reduced.

Increasing Pump Speed and Pressure During Later Washes—increasing the pump speed and therefore the force from the spray jets allows the dishwasher to better remove “stuck-on” food soil in later wash phases. Conventional wash systems maintain the same maximum flow rate during the early wash phases as the later phases. Because of this, the spray force from the jets is limited to the maximum flow rate that is available when the filter must operate with heavy food soils during early cycles. The invention's ability to increase the spray jet force during later wash phases allows it to better remove stuck-on or re-deposited food soils.

Changing Spray Arm Rotational Speed—this is an advantage over the prior art because this method allows the spray arm to better cover and clean the dishes without increasing the number of jets in the spray arm. Not having as many spray jets allows the total system flow rate to be lower, while the pressure and flow rate at the spray nozzles remains the same. This saves energy while giving the same cleaning action.

Noise Control by Controlling Pump/Motor Speed—controlling the motor pump speed in order to reduce the noise generated during certain cycles is discussed in the prior art. The prior art only addresses the steady noise generated during a phase of the wash cycle. Often the change from one type of noise or level of noise to another can be more objectionable than the steady state source of noise. This invention can slowly change the pump speed when transitioning from one phase of the wash cycle to another. For example when the machine is done filling with water the motor/pump speed and noise can be brought up to full level at a relatively slow rate. This is an advantage over the prior art because the changes in noise level are not as noticeable or objectionable even though the peak noise level may be the same.

Noise Control Through Improved Motor Cooling and Compartment Design—the three-phase motor used in the invention is more efficient than the single-phase motor/pump combinations known it the art. Because of this the motor/pump combination of this invention does not require a fan. This is an advantage because not using a fan requires less energy making the dishwasher more efficient; and the omission of a fan eliminates a significant noise source. In addition, because there is little heat generated by the motor/pump of the invention, the motor compartment can be sealed air tight and easily sound insulated without causing motor heat rise problems. If single-phase motors used in the art do not use a fan they can run hotter making it more difficult to insulate the motor compartment without causing heat rise problems.

Noise Control Through Elimination of 120 Hz Torque Pulsations—the motor/pump system of this invention does not generate 120 Hz torque pulsations. Single-phase motor/pump designs generate a 120 Hz torque pulsation, which in turn excites the structure of the dishwasher causing noise problems. The invention is an improvement over the prior art because it is inherently quieter.

Maintaining Optimum Flow Rate When Operating One or Two Spray Arms—the invention can decrease or increase the motor/pump speed when another spray arm is brought into operation. This is an advantage because if a wash pump system was already drawing all the water through the filter system that the filter could handle without clogging and another spray arm was brought into the system, the flow rate would increase and the filter would clog.

Ability to Start After Long Periods of Non-Use—the motor/pump system of the invention can provide a high level and/or pulsating starting torque to the motor if the conditions indicate that the motor shaft seal has become stuck.

### BRIEF DESCRITPION OF THE DRAWINGS

The invention is better understood by reading the following detailed description of the invention in conjunction with the accompanying drawings.

FIG. 1 illustrates an operational view of a dishwasher motor/pump system in accordance with an exemplary embodiment of the invention.

FIG. 2 illustrates an operational view of a dishwasher motor/pump system to control optimal filter operation during the wash process.

FIG. 3 illustrates an operational view of a dishwasher motor/pump system to increase motor/pump speed during later phases of the wash process.

FIG. 4 illustrates an operational view of a dishwasher motor/pump system to control spray arm rotational speed to improve control of the wash process.

FIGS. 5A-5B illustrate an operational view of sources of noise in a conventional dishwasher single phase motor/pump system and a comparative operational view for a quiet motor/pump system in accordance with an exemplary embodiment, respectively.

FIGS. 6A-6B illustrate operational views of a dishwasher motor/pump after a normal period of non-use and after a prolonged period of non-use, respectively.

### DETAILED DESCRIPTION OF THE INVENTION

The following description of the invention is provided as an enabling teaching of the invention in its best, currently known embodiment. Those skilled in the relevant art will recognize that many changes can be made to the embodiments described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and may even be desirable in certain circumstances and are a part of the present invention. Thus, the following description is provided as illustrative of the principles of the present invention and not in limitation thereof, since the scope of the present invention is defined by the claims.

The invention uses a speed-controlled induction motor to drive a dishwasher circulation pump or drain pump. The motor/pump's speed can be adjusted to provide a wide variety of advantageous results, depending on various conditions that arise during the course of the dishwasher's cycle. The motor speed can be slowed when the pump is detected to be drawing in an increasing amount of air into the pump inlet. During later wash phases, the motor speed can be increased when food soils are light and the loading on the filtration is very light. The motor can also be slowed for operation during evening hours in order to produce less noise.

In addition to being speed controlled, the motor is a three-phase type of motor, the three-phase power supplied by the motor's controller. A three-phase motor provides a significant advantage over conventional, single-phase motors that are commonly used in dishwashers. Conventional single-phase asynchronous induction motors and single-phase synchronous permanent magnet motors currently used in the art suffer from 120 Hz torque pulsations. These torque pulsations are transmitted to the structure of the dishwasher and ultimately generate acoustical noise, which is difficult to control. Three-phase motors, on the other hand, generate a constant torque during 360° of rotation; therefore, there are no torque pulsations. This aspect of the invention makes three-phase motors inherently quieter than the widely used single-phase motors.

Another advantage of the three-phase motor design is its efficiency. Many single-phase motor designs suffer from a relatively low level of efficiency. The electrical power that is not converted to mechanical power will be converted to heat. This often requires the conventional motor to use fans attached to the motor shaft to help cool the motor and vent openings (louvers) in the motor compartment. The fans are a drain on the shaft power, which then causes the motor to draw more power, thus costing more to manufacture and generating more noise. Opening vents or louvers in the motor compartment allow noise from the motor compartment and splash noise from the underside of the dishwasher to escape into the room more easily.

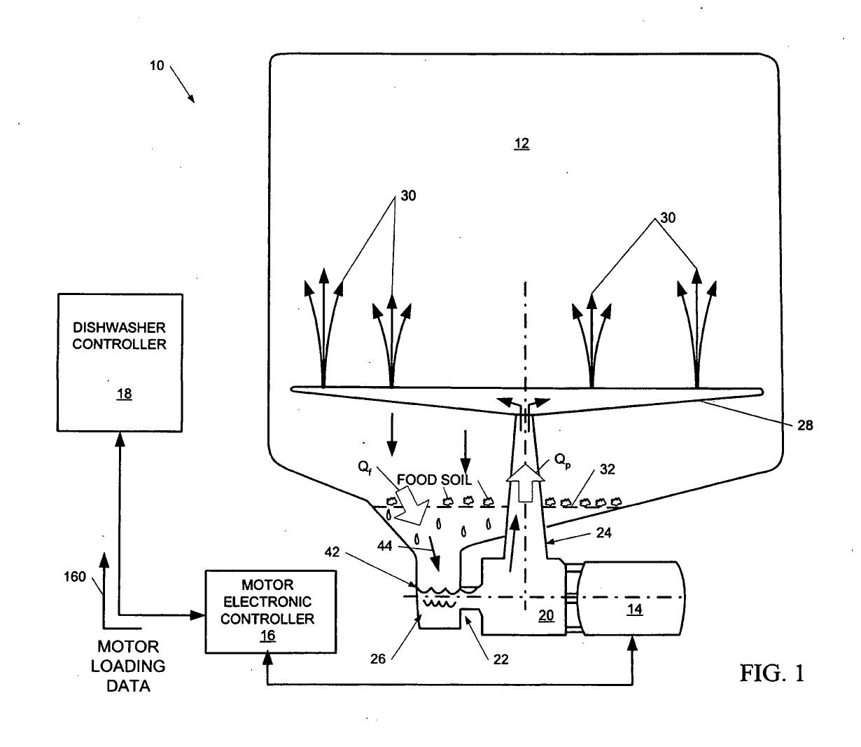

FIG. 1 illustrates an operational view of a dishwasher motor/pump system in an exemplary embodiment. A dishwasher 10 includes a dishwasher tub 12 that is capable of receiving dishes in trays (not shown) and includes a motor 14 that controls a pump 20. The motor 14 is connected to a motor electronic controller 16, which, in turn, is connected to a dishwasher controller 18. The pump 20 has a pump suction inlet 22 that receives water from the dishwasher tub. The pump also has a pump discharge 24, which generally is positioned above the pump, and is connected to a spray arm 28. Water from the dishwasher tub 12 is suctioned by the pump 20 through the pump suction inlet 22 and forced through the pump discharge 24 to the spray arm 28. The spray arm 28 then disperses the pumped water into the dishwasher tub 12 through water jets 30. The water jets 30 are disposed along the spray arm 28 and can include any number or configuration that allows the pumped water to be dispersed to dishes or other items in the dishwasher tub 12 to remove debris or other food/soil on the dishes during operation of the dishwasher.

Water from the dishwasher tub 12 normally collects towards the bottom of the tub 12 into sump 26 under the force of gravity. The sump 26 is connected to the pump suction inlet 22 to allow water to be communicated from the dishwasher tub 12 into the pump 20. The sump 26 can be of any form and merges with the pump suction inlet 22 to allow a large enough volume of water to proceed therethrough at a rate dictated by the pump 20. The filter 32 generally is disposed in the dishwasher tub 12 above the sump 26. The filter 32 spans the opening above the sump 26 to filter all water received in the sump 26 through the pump suction inlet 22 into the pump 20. The filter holes in this full-flow filter 32 generally are formed smaller than conventional filters, which are designed for a worst-case soil load.

This invention is capable of accomplishing several sophisticated and desirable functions with regard to dishwashers.

Maintaining Optimal Filter Operation

During the first several wash phases of a dishwasher's operation when soil loads are very high, the filtration system may begin to become overwhelmed or clogged with food debris. When this happens water cannot pass through the filter at a rate high enough to keep up with the intake of the pump. Eventually the water level at the intake to the main pump will fall and air will be drawn into the pump inlet. When this happens the load on the motor/pump decreases, which is then detected by the motor controller.

As further illustrated in FIG. 1, in a first state of dishwasher operation, the soil load in the wash water is high, partially blocking the filter 32. The total flow rate through the filter, Q_{f}, falls below the total flow rate through the pump, Qₚ. Since Q_{f} is less than Qₚ, the water level 42 at the pump inlet 22 falls allowing water and air 44 to enter the pump 20. Because air is now entering the pump, the torque load from the pump 20 is sensed to decrease by the motor controller 16 which sends motor loading data (signal 160) to the dishwasher controller 18.

When the motor/pump loading falls because water cannot pass through the filter at a rate equal to or greater than the flow rate of the pump, the speed of the motor/pump is controlled to a lower speed by the machine's microprocessor. Because the motor/pump is now running at a lower speed, the flow rate into the pump is also reduced. The reduction in speed of the motor/pump can continue until the flow rate through the filter matches the flow rate into the pump. This allows the filter system to operate at peak efficiency without having to employ other means to clean the filter.

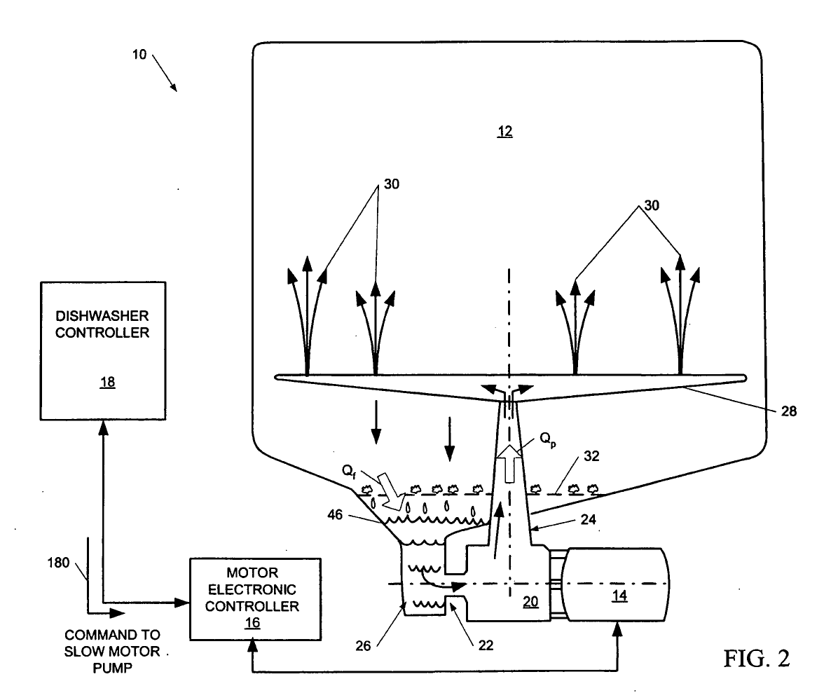

As illustrated in FIG. 2, in response to the torque load falling from the pump 20, the dishwasher controller 18 signals (command 180) the motor controller 16 to decrease the motor/pump speed. When the motor/pump speed decreases, the total flow rate, Qₚ, through the pump 20 also decreases. The speed and flow rate of the pump continue to decrease until Q_{f} is slightly larger than Qₚ. When Q_{f} is greater than Qₚ, the water level 46 at the pump inlet 22 rises until the pump inlet 22 is again submerged and no air can be drawn into the pump 20. This process continues until Q_{f} equals Qₚ and an optimal steady state is reached.

Increasing Pump Speed and Pressure During Later Washes

After the first several wash phases, i.e., the period between when the machine fills with a fresh charge of water from the water inlet valve until that volume of water, now laden with food soil, is pumped out of the machine and down the drain, the amount of food soil suspended in the wash water is decreased significantly.

When the soil load in a dishwasher changes significantly the requirements of the motor/pump system for the machine's wash system to operate at an optimum level change as well. During the first several wash phases the flow rate through the pump is limited by the filter's ability to pass enough soil laden water through the filter media to keep up with the requirements of the pump's suction inlet.

With motor/pump systems currently used in dishwashers the size, capacity and speed of the pump and motor need to be designed to operate at a flow rate close to the capacity of the filter during the first few cycles when soil loads are high. If the pump system's flow rate because of its size and speed is significantly higher than the filter's ability to operate at high soil loads, filter clogging will become a serious problem.

The present inventive design can operate the wash system at a higher flow rate during later wash phases when the soil loads are low and the capacity of the filter system to pass water increases significantly. Because of the higher flow rate, more mechanical cleaning action from the impulse of the water striking the dishes will be available during later wash phases to rinse the dishes and remove “stuck-on” food soils such as starches.

This is important because starchy food soils, e.g., mashed potatoes, have a tendency to become dissolved in the wash water during early and middle wash phases. Often by the last phases these very small starch deposits “glue” themselves to the dishes. Mechanical action from the impulse of the wash water is often the best way to remove these soils. If the starches are not removed, they are not usually visible after the dishes have dried, but can be felt on the smooth surface of the dishes.

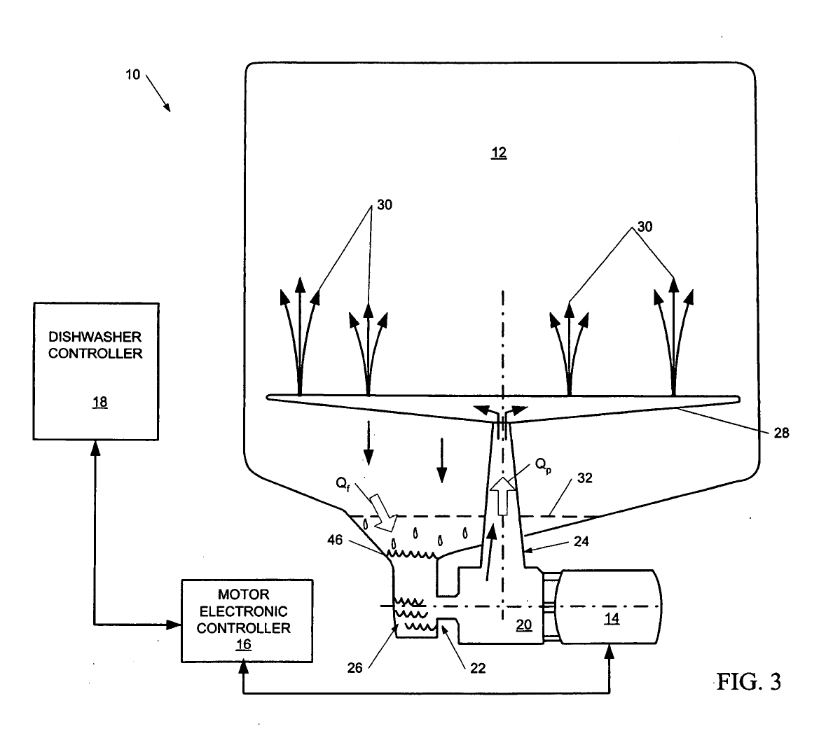

FIG. 3 illustrates the state of the dishwasher during the later wash phases. Most of the food debris is gone and the filter 32 is not blocked by such debris. Since the filter 32 is now clean, the flow rate, Q_{f}, through the filter 32 can increase significantly. The speed of the motor/pump is increased and, therefore, the flow rate, Qₚ, through the pump 20 is also increased. As Qₚ increases, flow rate Q_{f} through the filter also increases. When the dishwasher controller 18 increases the motor/pump speed, the flow rate and pressure in the spray arm 28 also increase, thereby allowing the impulse from the spray jets 30 to increase.

Changing Spray Arm Rotational Speed to Improve Coverage

Most of the spray arm systems used in dishwashers currently known in the art use fixed nozzle designs. The rotation of the spray arm is generally accomplished by having a number of the spray nozzles set at various angles from the vertical. Reaction forces from these angled jets of water cause the spray arm to rotate. If the pressure and flow rate through the spray arm are increased then the speed of rotation also increases. The speed of rotation of the spray arm can have a significant effect on how well the wash water covers all of the dishes in the rack system.

The motor/pump of the invention can adjust the rotational speed of the spray arms by changing the speed of the motor pump system. If the speed of the motor/pump is increased then the flow rate and pressure at the spray nozzles will also increase which in turn increases the speed of rotation of the spray arm. By adjusting the speed of rotation of the spray arms, the wash cycle can be tailored for different dish loading and rack configurations.

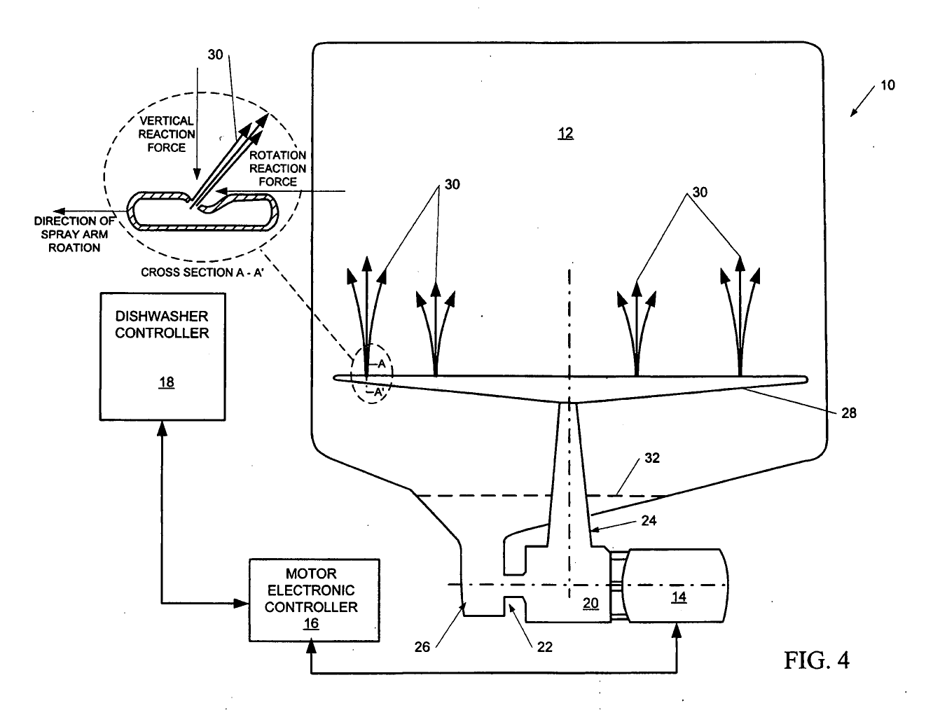

FIG. 4 illustrates an operational view of the spray arm 28 with angled spray jets 30 along with a cross-sectional view through a section of the spray arm 28 and angled jets 30. The cross-sectional view depicts the direction of rotation of the spray arm 28 and also indicates the directions of the vertical reaction force and rotational reaction force on the spray arm 28.

Noise Control by Controlling Motor/Pump Speed

There are several ways in which noise can be controlled by adjusting the speed of the motor/pump system. The simplest and most obvious method which has been disclosed in the prior art is to decrease the noise generated by the dishwasher by decreasing the speed of the motor/pump system and therefore the pressure and flow rate of the wash system. The resulting reduction in pressure and flow rate of the wash system in turn reduces the noise from spray jets striking the dishes and the side of the dishwasher tub.

Changes in noise levels can be more noticeable and objectionable to consumers than a steady level of noise. When a conventional dishwasher changes from a wash state where the wash pump and motor do not run to one where the motor and pump do operate the sudden change in noise level can be noticeable and objectionable.

The present invention largely eliminates this sudden change in noise level by slowly increasing and decreasing the speed of the motor/pump system when the motor/pump is started and stopped.

Noise Control Through Improved Motor Cooling and Compartment Design

The single-phase motors currently used in the art when compared to a three-phase motor are relatively inefficient. Any power provided to the motor that is not converted into useful shaft power is converted to heat. Because of this, conventional dishwasher motors often must have fans incorporated into their designs in order to help cool the motor windings and laminations. The fan is detrimental to dishwasher performance in two ways: (1) it is a patristic drain on the motor, requiring more power to be used by the motor than would be the case if the motor could run cool enough without it; and (2) the operation of the fan itself is a source of noise, which then must be controlled.

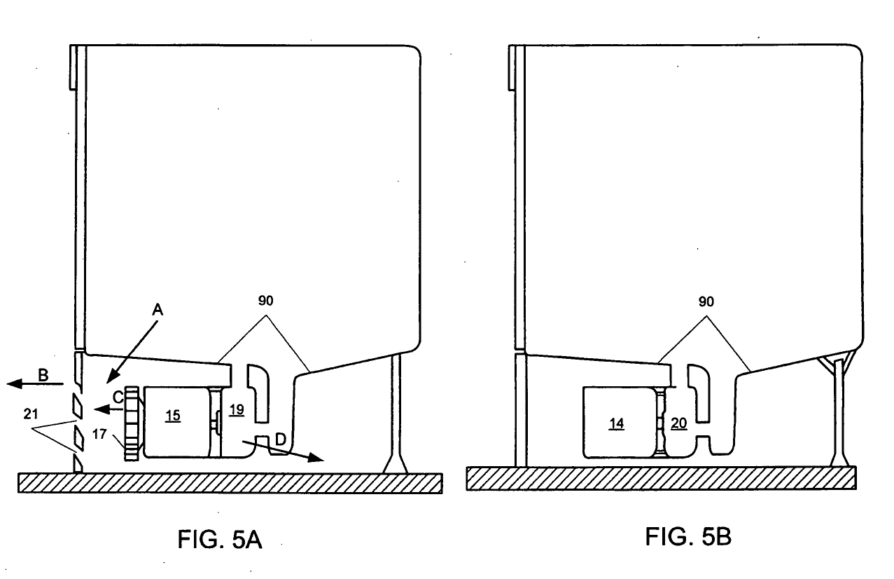

FIG. 5A illustrates an operational view of a conventional dishwasher with a single-phase motor/pump system. Motor compartment 90 includes pump 19, single-phase motor 15, fan 17 and vents 21. Vents 21 are often required in motor compartment 90 if the motor 15 is inefficient. Wash noise (arrow A), 120 Hz pulsations (arrow B), fan noise (arrow C) and pump noise (arrow D) can radiate from the vent openings.

This invention utilizes a three-phase motor that is more efficient than single-phase induction motors. Because over 90% of the power supplied to the motor is converted to useful shaft power and only a small amount is then converted to heat no fan is required to keep the motor cool. Because of this, the motor does not generate any fan noise. Another advantage is safety. Because the motor does not get as hot as the inefficient single-phase motors, the chance of fire is reduced.

The relatively large amount of heat generated by a single-phase dishwasher motor often requires that the motor compartment be vented. These vent openings allow a direct path for noise, in the objectionable mid to high frequencies, to escape from the dishwasher motor compartment and into the room. Because of the efficiency of the inventive design, no ventilation is required in the motor compartment. Being able to effectively seal the motor compartment greatly aids noise control and is a significant improvement in the dishwasher.

FIG. 5B illustrates the dishwasher with three-phase motor/pump system of the present invention. Motor compartment 90 includes pump 20 and motor 14 as shown in other figures. However, the invention does not require any fan or vents in the motor compartment 90.

Noise Control Through Elimination of 120 Hz Torque Pulsations

The torque produced at a given speed by a single-phase motor is not constant, but pulsates at twice the line frequency (120 Hz on a 60 Hz system) around a median value. These torque pulsations are inherent to all single-phase motors and are a source of significant noise and vibration in a dishwasher.

Three-phase motors like the one used in this invention produce a constant torque value at a given speed. Because of this, three-phase motors do not suffer from the torque pulsations and resulting noise and vibrations generated by single-phase motors. This invention is inherently less noisy than motor/pump systems currently known in the art that utilize single-phase motors. The 120 Hz noise generated by most dishwasher motors is difficult to contain often requiring expensive and only partially effective isolation methods to contain the vibrations.

Maintaining Optimal Flow Rate When Operating One or Two Spray Arms

Over the years, many dishwashers have become known in the art that operate multiple spray arms in certain combinations. Usually an upper or lower spray arm are operated one at a time or together. When the dishwasher switches from two spray arms to only one the flow resistance of the system changes and as a result, the flow rate through the system also changes.

If a dishwasher has an optimum amount of water passing through the filter when the machine is operating only one spray arm, and an additional spray arm is brought into the system and the pump speed remains constant, the flow rate through the system will increase because the flow resistance of the system has decreased. This increased flow rate may not be optimum for the system's wash performance. The inventive design can adjust the speed of the motor/pump to maintain a more consistent and optimum flow rate throughout the wash cycle when the number of spray arms in operation is changed.

Ability to Start After Long Periods of Non-Use

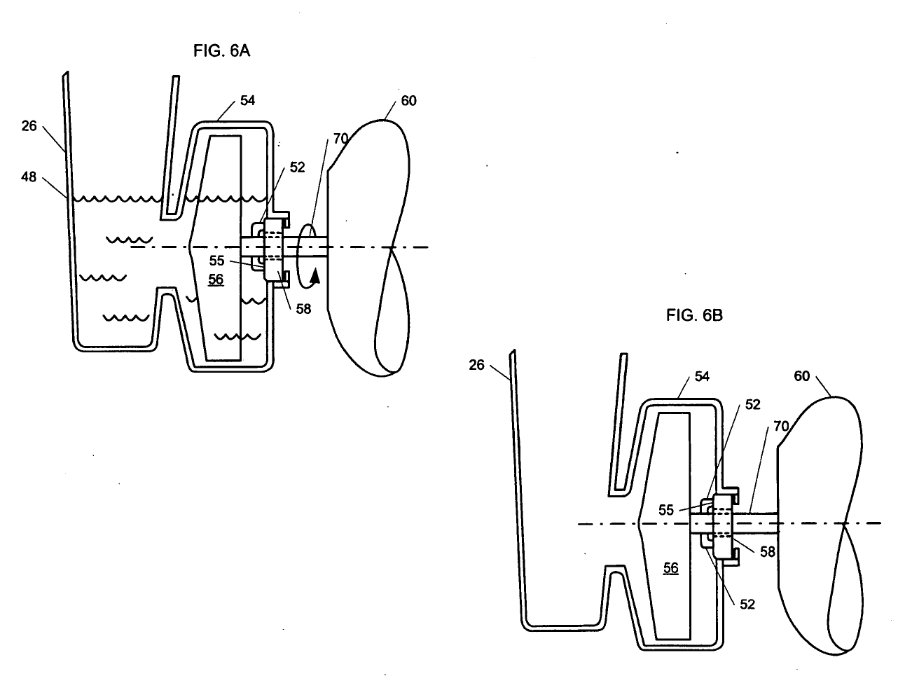

When most dishwashers finish their wash cycles there remains a small amount of water left in the lower portions of the pump. Usually this residual water level is high enough to keep the impeller shaft and seal submerged until the machine's next use. FIG. 6A illustrates the situation in the dishwasher after a normal period of non-use. It depicts pump housing 54, pump impeller 56, residual water level 48 in sump 26, shaft 70 and motor 60. the pump seal has a rotating portion 52 and a stationary portion 58 that contact each other at seal interface 55.

After long periods of non-use all of the residual water in the bottom of the dishwasher pump can evaporate. When this happens the rotational and stationary faces of the seal can “glue” themselves tightly together making it very difficult for the motor/pump to start the next time the machine is used. This phenomenon is sometimes referred to as “vacation home syndrome”. FIG. 6B depicts this situation in the dishwasher. All water has evaporated from sump 26. Residue from wash fluid dries on seal interface 55.

Most single-phase motors used in dishwashers have a relatively low starting torque. Often conventional dishwasher motors do not have enough torque to start after long periods of non-use when the seal faces have become stuck together. When this happens an expensive service call is usually required. The three-phase motor used in this invention is capable of a relatively high amount of starting torque compared to comparably sized single-phase motors. Furthermore, if the motor is sensed not to be starting normally by the motor controller, the starting torque can be momentarily increased or pulsed in order to aid in breaking the seal free.

Those skilled in the art will appreciate that many modifications to the preferred embodiment of the present invention are possible without departing from the spirit and scope of the present invention. In addition, it is possible to use some of the features of the present invention without the corresponding use of other features. Accordingly, the foregoing description of the preferred embodiment is provided for the purpose of illustrating the principles of the present invention and not in limitation thereof, since the scope of the present invention is defined solely by the appended claims.

What is claimed is:

1. A dishwasher comprising:
a pump for discharging water into a dishwasher tub;
a speed-controlled induction motor coupled to the pump to drive the pump during dishwasher operation;
a motor controller operationally connected to the induction motor to control the speed of operation of the induction motor; and
a dishwasher controller operationally connected to the motor controller for sending signals to, and receiving signals from, the motor controller during operation.

2. The dishwasher of claim 1 wherein the motor controller detects changes in load on the induction motor and pump and provides a motor loading data signal to the dishwasher controller.

3. The dishwasher of claim 2 wherein the dishwasher controller sends a signal to the motor controller to change the speed of the induction motor based on the motor loading data signal.

4. The dishwasher of claim 2 wherein the motor controller detects a decrease in load on the induction motor and the dishwasher controller sends a command back to the motor controller to decrease the speed of the induction motor.

5. The dishwasher of claim 1 wherein the induction motor is a three-phase motor.

6. The dishwasher of claim 1 wherein the induction motor provides a constant torque corresponding to the speed of operation of the induction motor.

7. The dishwasher of claim 1 wherein the pump is a water circulation pump and includes a pump inlet and a pump discharge.

8. The dishwasher of claim 1 wherein the pump is a drain pump.

9. The dishwasher of claim 4 further comprising a spray arm coupled to the pump discharge and including a plurality of spray jets.

10. The dishwasher of claim 9 wherein the plurality of spray jets are angled with respect to the spray arm.

11. The dishwasher of claim 9 wherein a speed of rotation of the spray arm increases in response to an increase in a water flow rate and pressure at the spray jets.

12. The dishwasher of claim 9 wherein the increase in the water flow rate and pressure at the spray jets is caused by an increase in speed of the induction motor and pump.

13. The dishwasher of claim 7 further comprising a sump connected to the pump inlet and a filter disposed in the dishwasher tub above the sump to block food debris from entering the sump.

14. The dishwasher of claim 13 wherein the motor controller detects a decrease in a torque load from the pump when a water flow rate through the filter decreases allowing air to enter the pump.

15. The dishwasher of claim 14 wherein the motor controller decreases the speed of the motor and pump until a water flow rate through the pump equals the flow rate through the filter.

16. A method for operating a dishwasher to clean food debris from a plurality of items in the dishwasher during a wash cycle, comprising the steps of:
filling a dishwasher tub with a fresh charge of water from a water inlet valve;
pumping the water through a pump discharge to a plurality of spray jets positioned on a spray arm that rotates during operation of the dishwasher; and
controlling a flow rate of the water through the pump discharge based on a phase of the wash cycle and a condition of a filter.

17. The method for operating a dishwasher of claim 16 further comprising detecting a change in a torque load on a pump motor and sending a data signal to a controller to indicate the torque load.

18. The method for operating a dishwasher of claim 17 comprising sending a signal from the controller to change the speed of the pump motor.

19. The method for operating a dishwasher of claim 17 comprising detecting a decrease in torque load on the pump motor and sending a signal from the controller to decrease the speed of the pump motor.

20. The method for operating a dishwasher of claim 17 wherein the pump motor is a three-phase induction motor.

21. The method for operating a dishwasher of claim 17 further comprising adjusting the pump motor's speed based on the condition that arises during the wash cycle.

22. The method for operating a dishwasher of claim 21 further comprising decreasing the speed of the pump motor when an increasing amount of air being drawn into a pump inlet is detected.

23. The method for operating a dishwasher of claim 21 further comprising increasing the speed of the pump motor when a load on the filter is detected as decreasing.

24. The method for operating a dishwasher of claim 16 further comprising decreasing the speed of the pump motor until the water flow rate through the pump equals the flow rate through the filter.

25. The method for operating a dishwasher of claim 17 further comprising detecting a decrease in torque load on the pump motor when the flow rate through the filter decreases allowing air to enter the pump.

26. The method for operating a dishwasher of claim 17 further comprising adjusting the speed of the pump motor until the flow rate through the pump discharge equals the flow rate through the filter.

27. The method for operating a dishwasher of claim 16 wherein the condition of the filter varies from partially blocked in an early phase of the wash cycle to clean at a later phase of the wash cycle.

28. The method for operating a dishwasher of claim 27 wherein the pump motor speed is decreased when the filter is partially blocked to decrease the flow rate through the pump and increased when the filter is clean to increase the flow rate through the pump.

29. The method for operating a dishwasher of claim 17 wherein the speed of rotation of the spray arm increases when the flow rate through the pump discharge increases.

30. The method for operating a dishwasher of claim 18 further comprising decreasing the speed of the pump motor for operation during evening hours.

31. The method for operating a dishwasher of claim 18 further comprising slowly changing the speed of the pump motor to prevent a sudden change in a noise level of the dishwasher during operation.

32. The method for operating a dishwasher of claim 17 further comprising increasing a starting torque on the pump motor after a long period of non-use of the dishwasher to overcome an adhesion between a rotating portion and a stationary portion of a pump seal.

33. A dishwasher system having a tub enclosure and a pump for pumping water into the tub enclosure during a wash cycle, comprising:
a variable speed motor coupled to the pump to drive the pump during dishwasher operation; and
a motor controller electrically connected to the motor to control the speed of operation during the wash cycle.

34. The dishwasher system of claim 33 further comprising a dishwasher controller electrically connected to the motor controller for sending signals to the motor controller to adjust the speed of the motor based on a detected loading condition.

35. The dishwasher system of claim 34 wherein the motor controller detects a load condition in the dishwasher and sends a loading data signal to the dishwasher controller.

36. The dishwasher system of claim 33 wherein the variable speed motor is an induction motor.

37. The dishwasher system of claim 36 wherein the induction motor is a three-phase motor.

38. The dishwasher system of claim 33 wherein the variable speed motor provides a constant torque corresponding to the speed of operation of the motor.

39. The dishwasher system of claim 33 wherein the pump is a circulation pump and includes a pump inlet and a pump discharge.

40. The dishwasher system of claim 39 further comprising a spray arm coupled to the pump discharge and including a plurality of spray jets.

41. The dishwasher system of claim 33 wherein the motor controller detects a decrease in a torque load form the pump when a water flow rate through a filter decreases allowing air to enter the pump.

42. The dishwasher system of claim 41 wherein the motor controller decreases the speed of the motor and pump until a flow rate through the pump equals a flow rate through the filter.
